(19) United States
(12) Patent Application Publication
(10) Pub. No.: US 2023/0306698 A1
(43) Pub. Date: Sep. 28, 2023

(54) SYSTEM AND METHOD TO ENHANCE DISTANT PEOPLE REPRESENTATION

(71) Applicant: Plantronics, Inc., Santa Cruz, CA (US)

(72) Inventors: Varun Ajay Kulkarni, Cedar Park, TX (US); Raghavendra Balavalikar Krishnamurthy, Austin, TX (US); Kui Zhang, Round Rock, TX (US)

(73) Assignee: Plantronics, Inc., Santa Cruz, CA (US)

(21) Appl. No.: 17/701,506

(22) Filed: Mar. 22, 2022

(51) Int. Cl. G06T 19/20; G06V 40/10; G06V 10/25; H04M 3/56; G06V 20/64

(52) U.S. Cl. CPC G06T 19/20; G06V 40/10; G06V 10/25; H04M 3/568; G06V 20/64; G06T 2219/2016

(57) ABSTRACT

A method including generating, by applying a three-dimensional pose estimation model to an original image generated by a camera, estimated three-dimensional poses for people in the original image. The estimated three-dimensional poses include distances from the camera. The method further includes determining, using the distances, a far people subset of the people. Each person of the far people subset corresponds to a distance from the camera exceeding a threshold distance. The method further includes, deriving, for the far people subset, regions of interest, upscaling a region of interest for a person of the far people subset to generate an upscaled region of interest, and generating, from the original image and the upscaled region of interest, an enhanced image.

### BACKGROUND

In a setup where a camera is used to zoom both near and far subjects, people at a far distance from the camera (e.g., people standing at the back of the conference room) do not appear very clear, even with a high-resolution camera. The camera zoom capability further deteriorates the image because the camera zoom capability does not preserve the original decoded quality. Therefore, it is challenging to render distant participants or objects with equal clarity as participants or objects that are near the camera. This limitation constrains other intelligent applications, such as framing and tracking far people, room analytics, etc.

### SUMMARY

In general, in one aspect, one or more embodiments relate to a method including generating, by applying a three-dimensional pose estimation model to an original image generated by a camera, estimated three-dimensional poses for people in the original image. The estimated three-dimensional poses include distances from the camera. The method further includes determining, using the distances, a far people subset of the people. Each person of the far people subset corresponds to a distance from the camera exceeding a threshold distance. The method further includes, deriving, for the far people subset, regions of interest, upscaling a region of interest for a person of the far people subset to generate an upscaled region of interest, and generating, from the original image and the upscaled region of interest, an enhanced image.

In general, in one aspect, one or more embodiments relate to a system including an input device with a camera, and a video module. The video model includes a three-dimensional pose estimation model, an image analyzer, and a super resolution model. The three dimensional pose estimation model is configured to generate estimated three-dimensional pose identifiers of poses of people in the original image that are located at various distances from the camera. The image analyzer is configured to derive, for a far people subset of the plurality of people, region of interest identifiers for regions of interest, wherein the far people subset are a subset of the people that exceed a threshold distance from the camera as defined in the plurality of estimated three-dimensional pose identifiers. The super resolution model is configured to upscale a first region of interest of the regions of interest for a first person of the far people subset to generate an upscaled first region of interest, and generate, from the original image and the upscaled first region of interest, an enhanced image.

In general, in one aspect, one or more embodiments relate to a non-transitory computer readable medium including computer readable program code for performing operations including: generating, by applying a three-dimensional pose estimation model to an original image generated by a camera, estimated three-dimensional poses for people in the original image. The estimated three-dimensional poses include distances from the camera. The operations further perform: determining, using the distances, a far people subset of the people. Each person of the far people subset corresponds to a distance from the camera exceeding a threshold distance. The operations further perform: deriving, for the far people subset, regions of interest, upscaling a region of interest for a person of the far people subset to generate an upscaled region of interest, and generating, from the original image and the upscaled region of interest, an enhanced image.

Other aspects of the invention will be apparent from the following description and the appended claims.

### BRIEF DESCRIPTION OF DRAWINGS

FIG. 1 shows a diagram of a system in accordance with disclosed embodiments.

FIG. 2 shows a flowchart in accordance with disclosed embodiments.

FIG. 3, FIG. 4, FIG. 5, and FIG. 6 show examples in accordance with disclosed embodiments.

### DETAILED DESCRIPTION

In general, embodiments of the invention are directed to a process for zooming into an original image to enhance images of far people who are located farther than a threshold distance from a camera, in order to provide an improved user experience. Due to the low image quality of the far people in the original image, the image quality of the region in the original image selected for zooming is enhanced. One or more embodiments generate estimated three-dimensional (3D) poses for people in the original image. An estimated 3D pose is a collection of structural points for a person, where each structural point may be represented as a 3D coordinate. In one or more embodiments, the 3D coordinate includes a location within the original image and a distance from a camera.

From the distance output (e.g., z-coordinate) in the 3D poses, a far people subset of the people in the original image is determined. For the far people subset, regions of interest (ROIs) within the original image are derived. A ROI for a person of the far people subset is upscaled by applying a super resolution machine learning model to the ROI to generate an upscaled ROI. For example, the ROI may be upscaled when the person in the far subset is speaking (e.g., as determined by active speaker identification (ASI)). The enhanced image with increased resolution is generated from the original image and the upscaled region of interest. Restricting the application of the super resolution machine learning model to ROIs corresponding to the far people subset reduces the computational overhead for enhancing the original image, thus increasing the scalability of the disclosed invention.

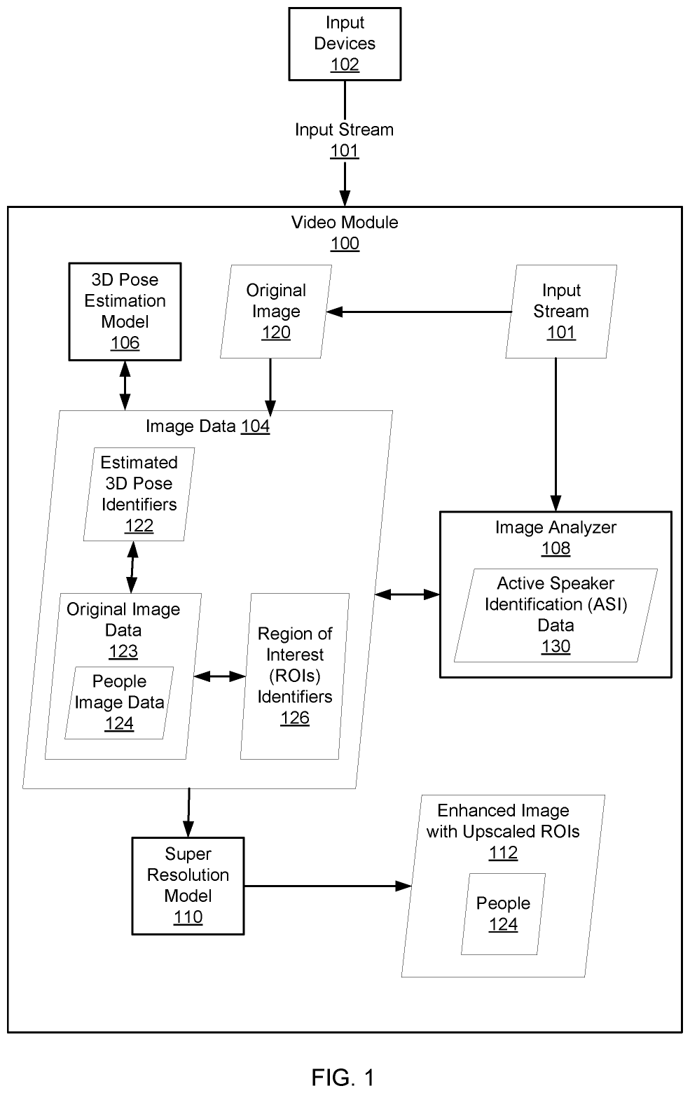

FIG. 1 shows a video module (100) of an endpoint. The endpoint may be a conferencing device, a videoconferencing device, a personal computer with audio or video conferencing abilities, a mobile computing device, or any similar type of communication device. The endpoint is configured to generate near-end audio and video and to receive far-end audio and video from remote endpoints. The endpoint is configured to transmit the near-end audio and video to the remote endpoints and to initiate local presentation of the far-end audio and video. The video module may be circuitry for processing video.

As shown in FIG. 1, the video module (100) includes functionality to receive an input stream (101) from an input device (102). The input device (102) may include one or more cameras and microphones and may include a single device or multiple separate physical devices. The input stream (101) may include a video stream, and optionally an audio stream. The input device (102) captures the input stream and provides the captured input stream to the video module (100) for processing to generate the near-end video. The video stream in the input stream may be a series of images captured from a video feed showing a scene. For example, the scene may be a meeting room with people that includes the endpoint. An original image (120) is an image in the series of images of the video stream portion of the input stream (101).

The video module (100) includes image data (104), a three-dimensional (3D) pose estimation model (106), an image analyzer (108), a super resolution model (110), and an enhanced image with upscaled regions of interest (ROIs) (112). The image data (104) includes original image data (123) representing the original image (120). The original image data (123) defines the pixel values of the pixels of the original image. Thus, the original image data (123) is a stored representation of the original image. Because people may be in the original image, the image data may include people image data (124). The people image data (124) is sub-image data within the original image data (123) that has the pixels values for people. As such, the people image data (124) corresponds to the portion of the original image that shows people. The portion of the original image data (124) that is the people image data (124) for one or more people may not be demarcated or otherwise identified in the original image (120).

The original image data (123) is related in storage to estimated 3D pose identifiers (122) and region of interest (ROI) identifiers (126) for people represented in the original image (120).

An estimated 3D pose identifier (122) is an identifier of an estimated 3D pose generated by the 3D pose estimation model (106). An estimated 3D pose is a collection of structural points for a person. The collection of structural points may be organized into a collection of line segments.

Each structural point may be represented as a 3D coordinate. In one or more embodiments, the 3D coordinate includes a location within the original image (120) and a distance from a camera of the input devices (102). For example, the location within the original image (120) may be represented as an x-coordinate and a y-coordinate, and the distance from the camera may be represented as a z-coordinate.

The 3D pose estimation model (106) may be a machine learning model that includes functionality to generate estimated 3D poses for one or more people (124) in an original image (120).

An ROI identifier (126) is an identifier of a region of interest (ROI). A ROI may be a region in the original image (120) corresponding to an estimated 3D pose for a person. Alternatively, the ROI may be a region in the original image (120) corresponding to any object of interest. The ROI may be enclosed by a bounding box generated as a function of the pose estimation.

The image analyzer (108) includes functionality to apply the 3D pose estimation model (106) and the super resolution model (110). The image analyzer (108) includes active speaker identification (ASI) data (130). The ASI data identifies locations in the original image corresponding to active sound sources. The ASI data (130) is generated by applying ASI algorithms to the video stream (101).

The ASI algorithms may be a part of the image analyzer or separate from the image analyzer. Different types of ASI algorithms may be used. For example, an ASI algorithm may be a sound source localization (SSL) algorithm or an algorithm that uses lip movement. For example, the SSL algorithms may be executed by an audio module (not shown) of the system. The SSL algorithms include functionality to locate an active sound source in an input stream (101). For example, the SSL algorithms may use directional microphones to locate an active sound source and save an identifier of the active sound source as ASI data (130). The active sound source is the location from which sound originates at a particular point in time. Because the original image (120) is captured at a particular point in time, the active sound source for the original image is the location shown in the original image that originated the sound in the audio stream at the same particular point in time. The active sound source may identify a person in the original image (120) who is speaking at a same point in time or who is speaking during a time interval in which the original image (120) is captured in the input stream (101).

The super resolution model (110) may be a machine learning model based on deep learning that includes functionality to generate, from the original image (120), an enhanced image with upscaled regions of interest (ROIs) (112). In other words, the super resolution model (110) may increase the scale (e.g., resolution), and hence improve the details of specific ROIs in the original image (120). For example, the resolution of a ROI in the original image (120) may be 50 pixels by 50 pixels and the corresponding upscaled ROI in the enhanced image with upscaled ROIs (112) may be 100 pixels by 100 pixels. In contrast to the super resolution model (110), traditional computer vision-based methods of upscaling may be inadequate (e.g., may introduce noise or blurriness) when removing defects and artifacts occurring due to compression. The machine learning model may be a Convolutional Neural Network (CNN) specially trained for video codec, that learns how to accurately convert low-resolution images to high-resolution images. Implementations of the super resolution model (110) may be based on the following algorithms: Enhanced Super Resolution Generative Adversarial Network (ESRGAN), Zero-Reference Deep Curve Estimation (Zero-DCE), etc.

The video module (100) includes functionality to transmit the enhanced image to a display device. The display device converts electrical signals to corresponding images that may be viewed by users of the endpoint. In one embodiment, the display device may be a touch sensitive display device that converts touch inputs from a user to electrical signals. The display device may be one of multiple display devices that are part of the endpoint.

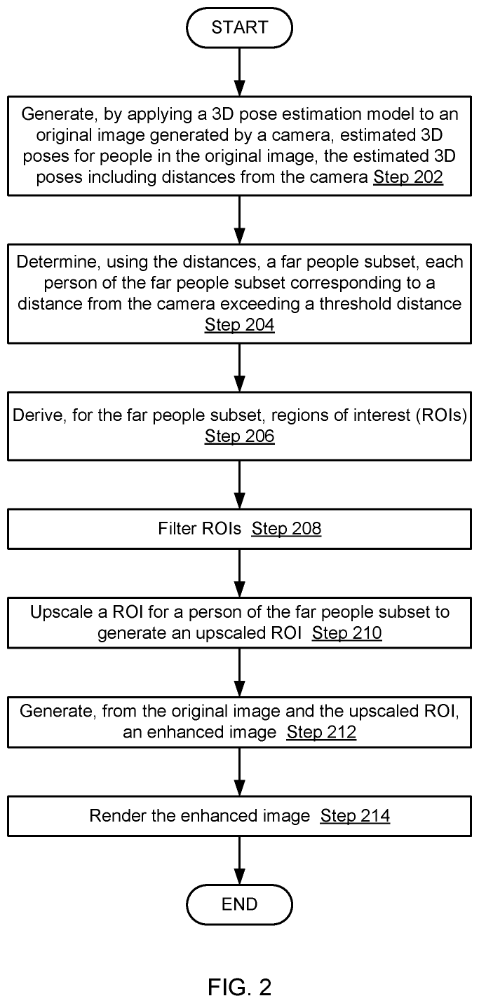

FIG. 2 shows a flowchart illustrating a method for providing an enhanced image in accordance with one or more embodiments of the invention. In Step 202, estimated three-dimensional poses for people in an original image are generated, by applying a three-dimensional (3D) pose estimation model to the original image. The video module may receive the original image from a camera over a network. Each estimated 3D pose includes a collection of structural points within the original image corresponding to a person. The estimated 3D poses include distances from the camera.

The original image may be preprocessed before applying the 3D pose estimation model. For example, the original image may be resized to conform to an image size accepted by the 3D pose estimation model. Continuing this example, the original image may be converted from an original image size (e.g., 1280 pixels by 720 pixels) to a modified image size (e.g., 500 pixels by 500 pixels) used by the 3D pose estimation model.

The 3D pose estimation model may predict the estimated 3D poses via a combination of identification, localization, or tracking of the structural points in the original image. The 3D pose estimation model may concurrently predict estimated 3D poses for multiple people or objects in the original image.

The goal of 3D pose estimation is to detect the X, Y, Z coordinates of a specific number of joints (i.e., keypoints) on the human body by using an image containing a person. Identifying the coordinates of joints is achieved by using deep learning models and algorithms that use, as input, either single 2D image or multiple 2D images as input and output X, Y, Z co-ordinates for each person in the scene. An example of a deep learning model that may be used is a convolutional neural network (CNN).

Multiple approaches to 3D pose estimation may be used to train a deep learning model capable of inferring 3D keypoints directly from the provided images. For example, a multi-view model is trained to jointly estimate the positions of 2D and 3D keypoints. The multi-view model does not use ground truth 3D data for training but only 2D keypoints. The multi-view model constructs the 3D ground truth in a self-supervised way by applying epipolar geometry to 2D predictions.

Regardless of the approach ([image to 2D to 3D] or [image to 3D]), 3D keypoints may be inferred using single-view images. Alternatively, multi-view image data may be used where every frame is captured from several cameras focused on the target scene from different angles.

In Step 204, a far people subset of the people is determined using the distances. Each estimated 3D pose for a person of the far people subset corresponds to a distance (e.g., z-coordinate) from the camera exceeding a threshold distance. For example, the threshold distance may be a distance beyond which image quality (e.g., resolution) begins to significantly degrade. The threshold distance may be a configuration parameter that is set to a range of a lens in the camera.

In Step 206, regions of interest (ROIs) are derived for the far people subset. An ROI may be a two-dimensional region (e.g., bounding box) that encompasses a person in the far people subset. The image analyzer may derive the ROI for the person using the structural points corresponding to the person. For example, the x-coordinates at the boundaries of the ROI may be the maximum and minimum x-coordinates of the structural points corresponding to the person. Similarly, the y-coordinates at the boundaries of the ROI may be the maximum and minimum y-coordinates of the structural points corresponding to the person. The ROI may be increased by an additional margin, for example, to provide a border region encompassing the person.

In Step 208, the image analyzer may filter the ROIs using ASI data received during a time interval. The ASI data identifies locations in the original image corresponding to active sound sources. The ASI data is generated by applying ASI algorithms to the input stream. ASI algorithms include sound source localization (SSL) algorithms and sound and lip movement detection algorithms to identify an active speaker. For example, the SSL algorithms may identify a location in the original image by triangulating sounds corresponding to an active sound source using a horizontal pan angle.

The image analyzer may filter the ROIs by removing one or more ROIs that fail to correspond to an active sound source during the time interval. For example, the image analyzer may remove an ROI that corresponds to a person in the far people subset who remained silent during the time interval. Continuing this example, the time interval may be the last three minutes. Thus, the remaining ROIs may correspond to people in the far people subset who have spoken during the time interval.

In Step 210, a region of interest (ROI) for a person of the far people subset is upscaled to generate an upscaled region of interest. The upscaled ROI is a representation of the ROI with increased resolution. For example, the resolution of the upscaled ROI may be comparable to the resolution of people whose corresponding estimated 3D pose is near the camera (e.g., within the threshold distance from the camera). The ROI may be upscaled by applying a super resolution machine learning model to the ROI. In one or more embodiments, the super resolution machine learning model concurrently upscales the ROIs for multiple people of the far people subset.

Restricting the application of the super resolution machine learning model to ROIs for the far people subset significantly reduces the computational overhead for enhancing the original image, thus increasing the scalability of the disclosed invention. For example, deep learning-based super resolution approaches may be computationally expensive when upscaling to high resolutions (e.g., resolutions exceeding 720 pixels).

In one or more embodiments, other machine learning models or computer vision algorithms may be used to upscale the ROI(s) instead of applying the super resolution machine learning model.

In Step 210, an enhanced image is generated from the original image and the upscaled region of interest. For example, the image analyzer may generate the enhanced image by replacing, in the original image, the ROI with the upscaled ROI. The image analyzer may increase the resolution of the ROI within the original image. Framing is the technique of narrowing an image to be on the person speaking such that other people who are not near that person are not displayed. Framing involves zooming in on that person so that the person is larger and more clearly visible. When zooming in on an active speaker who is far from the camera for framing purposes, due to the limitations of the camera lens, the zoomed portion of the image is of poor quality without sharpening. Meanwhile, a person who is near to the camera and therefore appears big due to more pixel coverage, the framing or focusing on that person is of good quality. The goal is to make the framing the same quality regardless of distance. One or more embodiments through application of super-resolution, make framing of the people regardless of distance the same quality when intended for a zoomed display.

In Step 214, the enhanced image is rendered. The video module may render the enhanced image by transmitting the enhanced image to a display device. Alternatively, the video module may transmit the enhanced image to a software application that sends the enhanced image to a display device.

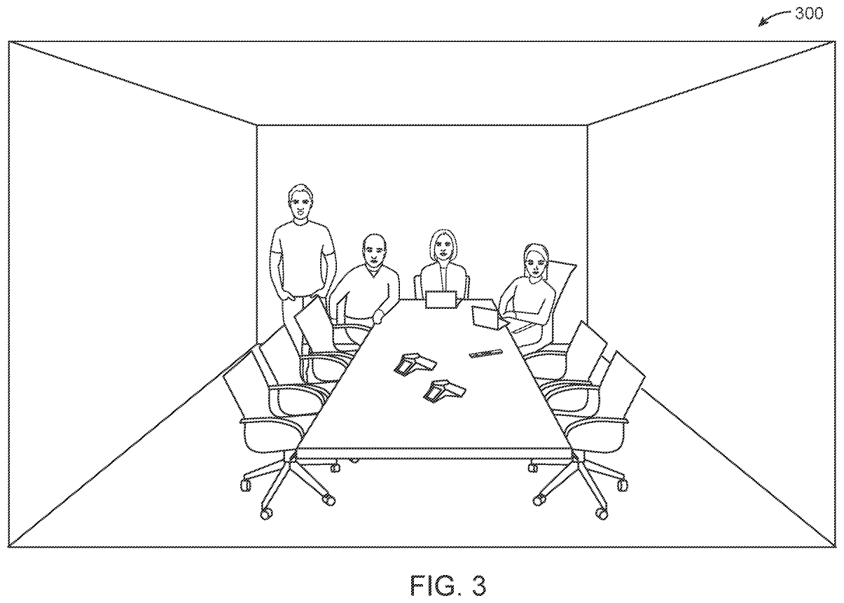

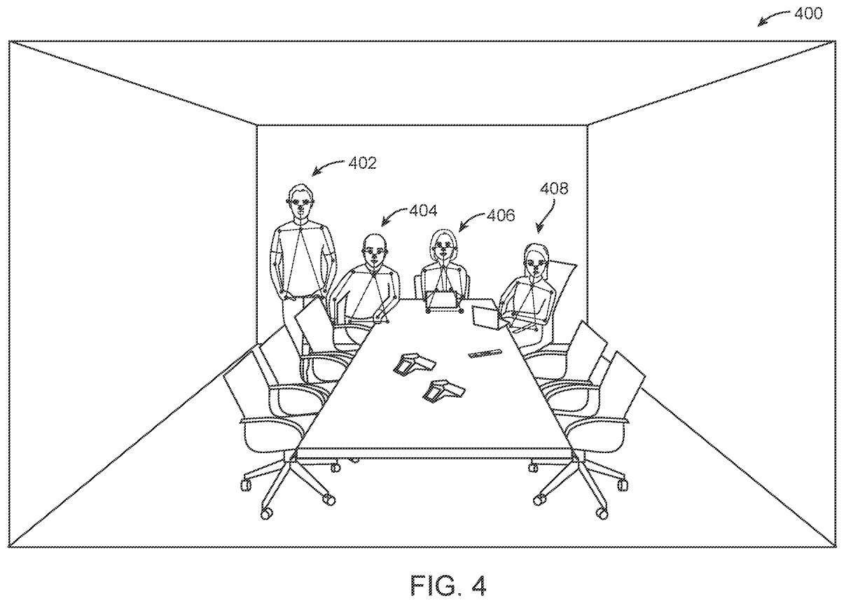

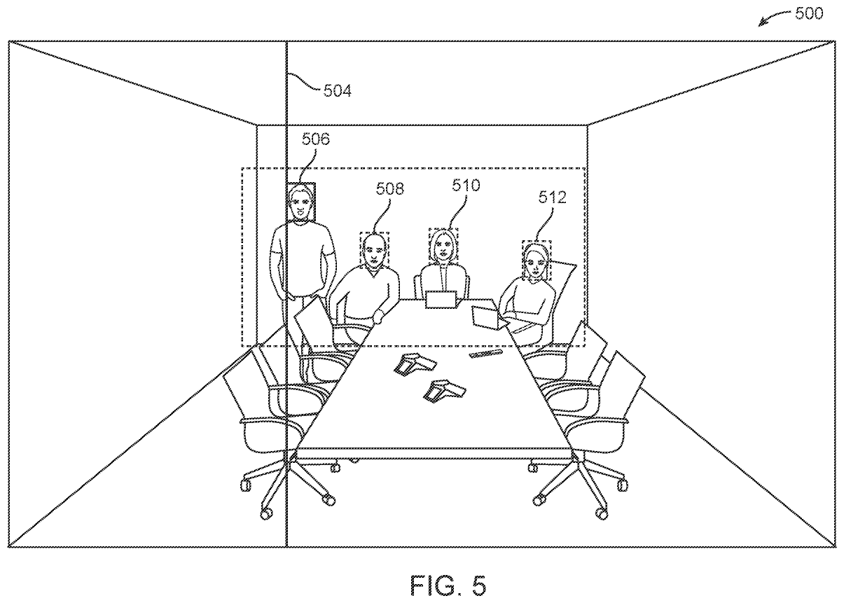

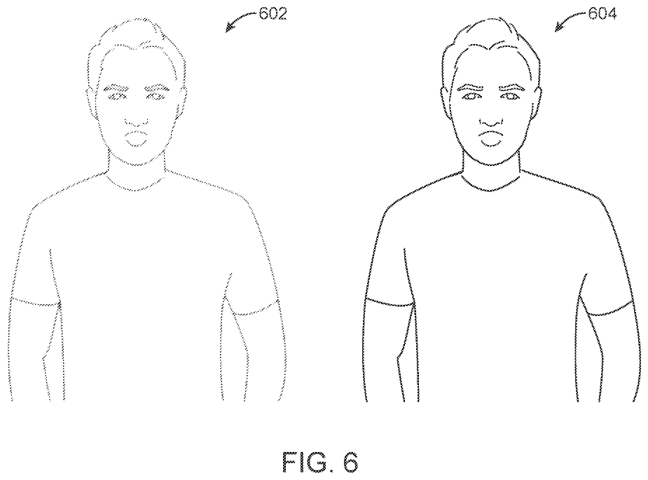

FIG. 3, FIG. 4, FIG. 5, and FIG. 6 show an example in accordance with one or more embodiments. In the example, although line drawings are used, the Figures represent an image in a video stream captured by a camera in a conference room. Other details and objects in the image may exist, such as wall art and other objects as well as additional people near the camera. The example is for explanatory purposes only and not intended to limit the scope of the invention. One skilled in the art will appreciate that implementation of embodiments of the invention may take various forms and still be within the scope of the invention.

FIG. 3 shows an original image (300) captured by a camera (not shown). The people in the conference room may be interacting using the conference system with remote users. The conference system may include a microphone array, speakers, and a display to display the remote people.

FIG. 4 shows the view (400) of FIG. 3 with 3D pose estimation points (402, 404, 406, 408) overlaid onto the people. A trained convolutional neural network model may be configured to identify the z-axis distance. Z-axis distance may be based on sizes of people, movement of people through various images, multi-views from different cameras and other features. The trained CNN model will output X, Y and Z co-ordinates of a specific number of joints (keypoints) on the human body for each person present in the scene.

FIG. 5 shows the view (500) with output of a sound source localization (SSL) algorithm. The active sound source (506) corresponds to a person speaking in a conference room. To perform the SSL, the SSL algorithm may use a CNN model to perform face detection on the original image of the video stream. From the CNN model, the SSL algorithm identifies faces and puts a bounding box around the faces (506, 508, 510, and 512). Bounding box (502) may be around all faces. The SSL algorithm may use the input from multiple speakers in the audio portion of the video stream to identify the pan angle of the sound source. The pan angle is the vertical line (504) and is determined based on the difference between the inputs of multiple microphones. The intersection of the vertical line (504) with a bounding box is the active sound source. In the example, the active sound source is the man standing. The SSL algorithm may also output a box around all identified speakers.

Another algorithm that may be used is a sound and lip movement detection algorithm Responsive to detecting sound, the video stream is analyzed to identify lip movement. The face with the most probable lip movement matching the sound is selected as the active speaker. In the example, the active speaker is person who is distant from a camera. That is, the distance between the person and the camera exceeds a threshold distance. In this example, the threshold distance is 12 feet, which is a range of a lens used in the camera.

Turning to FIG. 6, FIG. 6 shows a line drawing of a region of interest (ROI) without increasing the resolution (602) and with increasing the resolution (604) from the original image of FIG. 3. The line drawing is an imitation of the increase in resolution. In actuality, details such as the eyes may be blurred in the original image so as to not easily detectable to a person.

Continuing with the example, framing is performed on the active speaker to identify the region of interest. The framing uses the pose estimation model to identify the region of interest for the active speaker. The framing changes the view to be focused on the active speaker removing the others from the image. Further, enlargement is performed on the active speaker. The result of enlarging the region of interest is a low resolution image (602). Because the threshold distance is exceeded, an upscaled ROI with an increased resolution (604) is generated by applying the super resolution model to the ROI (602). In this example, the super resolution model implements the Efficient sub-pixel convolutional neural network (ESPCN) super resolution algorithm. The result is a super resolution image (604) with an increased resolution of two to four times the resolution of the original image. In the example, an ROI of 50×100 pixels per inch (ppi) becomes 100×200 ppi or 200×400 ppi.

Software instructions in the form of computer readable program code to perform the one or more embodiments may be stored, in whole or in part, temporarily or permanently, on a non-transitory computer readable medium. Specifically, the software instructions may correspond to computer readable program code that, when executed by a processor(s), is configured to perform the one or more embodiments.

Throughout the application, ordinal numbers (e.g., first, second, third, etc.) may be used as an adjective for Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, the term “or” in the description is intended to be inclusive or exclusive. For example, “or” between multiple items in a list may be one or more of each item, only one of a single item, each item, or any combination of items in the list.

While the disclosure describes a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
generating (202), by applying a three-dimensional pose estimation model to an original image generated by a camera, a plurality of estimated three-dimensional poses for a plurality of people in the original image, the plurality of estimated three-dimensional poses comprising a plurality of distances from the camera;
determining (204), using the plurality of distances, a far people subset of the plurality of people, each person of the far people subset corresponding to a distance from the camera exceeding a threshold distance;
deriving (206), for the far people subset, a plurality of regions of interest;
upscaling (208) a first region of interest of the plurality of regions of interest for a first person of the far people subset to generate an upscaled first region of interest; and
generating (210), from the original image and the upscaled first region of interest, an enhanced image.

2. The method of claim 1, further comprising:
rendering (212) the enhanced image.

3. The method of claim 1, further comprising:
receiving active speaker identification data (130) during a time interval, the active speaker identification data (130) identifying a plurality of locations in the original image corresponding to a plurality of sound sources; and
before upscaling the first region of interest, filtering, using the active speaker identification data (130), the plurality of regions of interest.

4. The method of claim 3, wherein filtering the plurality of regions of interest comprises:
removing, from the plurality of regions of interest, a region of interest that fails to correspond to a sound source during the time interval.

5. The method of claim 1,
wherein the plurality of estimated three-dimensional poses further comprises a plurality of structural points within the original image, and
wherein the plurality of regions of interest are derived using the plurality of structural points.

6. The method of claim 1, wherein upscaling the first region of interest comprises applying a super resolution machine learning model (110) to the first region of interest.

7. The method of claim 1, further comprising:
setting the threshold distance to a range of a lens in the camera.

8. The method of claim 1, further comprising:
resizing the original image (120) to conform to an image size accepted by the three-dimensional pose estimation model (106).

9. A system comprising:
an input device (102) comprising a camera for obtaining an original image (120); and
a video module comprising:
a three-dimensional pose estimation model (106) configured to generate a plurality of estimated three-dimensional pose identifiers (122) of poses of a plurality of people in the original image (120) that are located at a plurality of distances from the camera,
an image analyzer (108) configured to derive, for a far people subset of the plurality of people, a plurality of region of interest identifiers (126) for a plurality of regions of interest, wherein the far people subset are a subset of the plurality of people that exceed a threshold distance from the camera as defined in the plurality of estimated three-dimensional pose identifiers (122), and
a super resolution model (110) configured to:
upscale a first region of interest of the plurality of regions of interest for a first person of the far people subset to generate an upscaled first region of interest, and
generate, from the original image and the upscaled first region of interest, an enhanced image.

10. The system of claim 9, further comprising:
a display device for displaying the enhanced image.

11. The system of claim 9, wherein the image analyzer is further configured to:
before upscaling the first region of interest, filter, using active speaker identification data, the plurality of regions of interest, the active speaker identification data identifying a plurality of locations in the original image corresponding to a plurality of sound sources.

12. The system of claim 11, wherein filtering the plurality of regions of interest comprises:
removing, from the plurality of regions of interest, a region of interest that fails to correspond to a sound source during the time interval.

13. The system of claim 9,
wherein the plurality of estimated three-dimensional poses further comprises a plurality of structural points within the original image, and
wherein the plurality of regions of interest are derived using the plurality of structural points.

14. The system of claim 9, wherein the video module and input device is located in an endpoint of a conferencing system.

15. The system of claim 9, wherein the image analyzer is further configured to:
set the threshold distance to a range of a lens in the camera.

16. The system of claim 9, wherein the image analyzer is further configured to:
resize the original image to conform to an image size accepted by the three-dimensional pose estimation model.

17. A non-transitory computer readable medium comprising computer readable program code for performing operations comprising:
generating, by applying a three-dimensional pose estimation model to an original image generated by a camera, a plurality of estimated three-dimensional poses for a plurality of people in the original image, the plurality of estimated three-dimensional poses comprising a plurality of distances from the camera;
determining, using the plurality of distances, a far people subset of the plurality of people, each person of the far people subset corresponding to a distance from the camera exceeding a threshold distance;
deriving, for the far people subset, a plurality of regions of interest;
upscaling a first region of interest of the plurality of regions of interest for a first person of the far people subset to generate an up scaled first region of interest; and
generating, from the original image and the upscaled first region of interest, an enhanced image.

18. The non-transitory computer readable medium of claim 17, wherein the operations further comprise:
rendering the enhanced image.

19. The non-transitory computer readable medium of claim 17, wherein the operations further comprise:
receiving active speaker identification data during a time interval, the active speaker identification data identifying a plurality of locations in the original image corresponding to a plurality of sound sources; and
before upscaling the first region of interest, filtering, using the active speaker identification data, the plurality of regions of interest.

20. The non-transitory computer readable medium of claim 19, wherein filtering the plurality of regions of interest comprises:
removing, from the plurality of regions of interest, a region of interest that fails to correspond to a sound source during the time interval.
